(19) United States
(12) Patent Application Publication
(10) Pub. No.: US 2018/0061331 A1
(43) Pub. Date: Mar. 1, 2018

(54) DISPLAY APPARATUS, METHOD, AND MEDIUM FOR DISPLAYING AN IMAGE

(71) Applicant: CANON KABUSHIKI KAISHA, Tokyo (JP)

(72) Inventors: Takeshi Ikeda, Ebina-shi (JP); Yasuhiro Matsuura, Yokohama-shi (JP)

(21) Appl. No.: 15/681,117

(22) Filed: Aug. 18, 2017

(30) Foreign Application Priority Data
Aug. 26, 2016 (JP) 2016-165415

(51) Int. Cl. G09G 3/34

(52) U.S. Cl. CPC G09G 3/342; G09G 3/3413; G09G 2320/0646; G09G 2330/021; G09G 2320/045; G09G 2320/064; G09G 2320/041

(57) ABSTRACT

A display apparatus includes a light-emitting unit including light source portions, a display unit, a first determination unit which performs, on each light source portion, processing for determining a drive value, which is a value used to perform control to set a light emission brightness of the light source portion to a target brightness and a value regarding a drive time of the light source portion, based on the target brightness of the light source portion, and a correction unit which corrects the drive value for each light source portion in such a manner that, in a case where a total drive time which is a sum of a plurality of drive times respectively corresponding to the light source portions is greater than a threshold value, the total drive time becomes equal to or less than the threshold value, based on the drive value for each light source portion.

### BACKGROUND

### Field of the Disclosure

One or more aspects of the present disclosure generally relate to displays and more particularly, to a display apparatus for displaying an image, and a method and medium.

### Description of the Related Art

An improvement in the upper limit of brightness of an image displayed by a display apparatus (a display image) and an improvement in contrast of the display image are desired. A liquid crystal display apparatus can perform local dimming control on a backlight unit to increase the display brightness (the brightness of a screen) of white and decrease the display brightness of black. With this local dimming control, both an improvement in the upper limit of brightness of the display image and an improvement in contrast of the display image can be attained.

However, if the light emission brightness of the backlight unit is increased, although the display brightness can be increased, the power consumption of the backlight unit would also increase. In particular, if the light emission brightness of the backlight unit is increased with respect to the entire area of the screen, the power consumption of the backlight unit increases significantly. Then, there is an upper limit to electric power (for example, electric power which a power source is able to output to the liquid crystal display apparatus or electric power which is able to be input to the liquid crystal display apparatus), and, when the light emission brightness of the backlight unit is increased, the electric power for the liquid crystal display apparatus may exceed the upper limit. If the electric power for the liquid crystal display apparatus exceeds the upper limit, the screen may become suddenly dark or an image may become suddenly undisplayed so as to protect, for example, a power source or a power-supply circuit of the liquid crystal display apparatus.

A technique to prevent the electric power for a display apparatus from exceeding the upper limit is discussed in, for example, Japanese Patent Application Laid-Open No. 2006-119465. In the technique discussed in Japanese Patent Application Laid-Open No. 2006-119465, the power consumption of the display apparatus is estimated based on image data, and, in a case where the estimated power consumption is greater than a threshold value, the image data is corrected in such a manner that the estimated power consumption becomes equal to or less than the threshold value.

In a case where the backlight unit includes a plurality of light sources (light-emitting elements), the luminous efficiency (the luminous efficiency of each light source) may vary between the plurality of light sources. The variation in luminous efficiency arises, for example, during manufacturing of light sources. Specifically, a variation in voltage applied to each light source occurs due to manufacturing errors. As a result, a variation in luminous efficiency occurs. The luminous efficiency changes depending on, for example, a temperature change of the light source or an aged deterioration of the light source. Therefore, the variation in luminous efficiency also arises from, for example, a temperature change of the light source or an aged deterioration of the light source.

Then, in a case where a variation in luminous efficiency occurs, in order to perform control to set the light emission brightness of each light source to a target brightness (a target light emission brightness), the luminous efficiency of each light source needs to be taken into consideration. The power consumption of a liquid crystal display apparatus depends on a drive value for driving a backlight unit (light sources). Then, in a case where the drive value is determined in consideration of the luminous efficiency of each light source, the drive value can be varied.

Therefore, in the case of a method of estimating power consumption only based on image data, the power consumption may sometimes not be able to be estimated with a high degree of accuracy. In other words, in the technique discussed in Japanese Patent Application Laid-Open No. 2006-119465, the power consumption may sometimes not be able to be estimated with a high degree of accuracy. Then, in the technique discussed in Japanese Patent Application Laid-Open No. 2006-119465, in order to surely prevent the electric power for the display apparatus from exceeding the upper limit, it is necessary to use a value of electric power smaller to some extent than the upper limit as a threshold value. Therefore, in the technique discussed in Japanese Patent Application Laid-Open No. 2006-119465, displaying which efficiently uses electric power (displaying which sufficiently uses the performance of the display apparatus or the performance of the power source) may sometimes not be able to be performed.

### SUMMARY

According to one or more aspects of the present disclosure, a display apparatus includes a light-emitting unit including a plurality of light source portions, a display unit configured to display an image by modulating light from the light-emitting unit based on image data, a first determination unit configured to perform, on each of the plurality of light source portions, determination processing for determining a drive value, which is a value used to perform control to set a light emission brightness of each of the plurality of light source portions to a target brightness and which is a value regarding a drive time of each of the plurality of light source portions, based on the target brightness of each the plurality of light source portions, and a correction unit configured to correct the drive value for each of the plurality of light source portions in such a manner that, in a case where a total drive time which is a sum of a plurality of drive times respectively corresponding to the plurality of light source portions is greater than a threshold value, the total drive time becomes equal to or less than the threshold value, based on the drive value for each of the plurality of light source portions.

According to one or more other aspects of the present disclosure, a control method for a display apparatus, which includes a light-emitting unit including a plurality of light source portions, and a display unit configured to display an image by modulating light from the light-emitting unit based on image data, includes performing, on each of the plurality of light source portions, determination processing for determining a drive value, which is a value used to perform control to set a light emission brightness of each of the plurality of light source portions to a target brightness and which is a value regarding a drive time of each of the plurality of light source portions, based on the target brightness of each the plurality of light source portions, and correcting the drive value for each of the plurality of light source portions in such a manner that, in a case where a total drive time which is a sum of a plurality of drive times respectively corresponding to the plurality of light source portions is greater than a threshold value, the total drive time becomes equal to or less than the threshold value, based on the drive value for each of the plurality of light source portions.

According to yet another aspect of the present disclosure, a computer-readable storage medium stores computer-executable instructions that, when executed by a computer, cause the computer to perform a control method for a display apparatus, which includes a light-emitting unit including a plurality of light source portions, and a display unit configured to display an image by modulating light from the light-emitting unit based on image data, the control method including performing, on each of the plurality of light source portions, determination processing for determining a drive value, which is a value used to perform control to set a light emission brightness of each of the plurality of light source portions to a target brightness and which is a value regarding a drive time of each of the plurality of light source portions, based on the target brightness of each the plurality of light source portions, and correcting the drive value for each of the plurality of light source portions in such a manner that, in a case where a total drive time which is a sum of a plurality of drive times respectively corresponding to the plurality of light source portions is greater than a threshold value, the total drive time becomes equal to or less than the threshold value, based on the drive value for each of the plurality of light source portions.

Further features of the present disclosure will become apparent from the following description of exemplary embodiments with reference to the attached drawings.

### BRIEF DESCRIPTION OF THE DRAWINGS

FIG. 1 is a block diagram illustrating a configuration example of a display apparatus according to a first exemplary embodiment.

FIGS. 2A and 2B illustrate an example of input image data and feature amounts thereof according to the first exemplary embodiment.

FIGS. 3A, 3B, and 3C illustrate an example of feature amounts, reference brightnesses, and target brightnesses according to the first exemplary embodiment.

FIG. 4 illustrates an example of a light emission brightness and a drive time according to the first exemplary embodiment.

FIG. 5 is a block diagram illustrating a configuration example of a display apparatus according to a second exemplary embodiment.

FIG. 6 illustrates a composite image according to the second exemplary embodiment.

### DESCRIPTION OF THE EMBODIMENTS

Hereinafter, one or more aspects of the present disclosure will be described with reference to the drawings. A first exemplary embodiment of the present disclosure is described below. Furthermore, while an example in which a display apparatus according to the present exemplary embodiment is a transmission-type liquid crystal display apparatus is described below, the display apparatus according to the present exemplary embodiment is not limited to the transmission-type liquid crystal display apparatus. The display apparatus according to the present exemplary embodiment only needs to be a display apparatus including a light-emitting unit and a display unit which displays an image by modulating light from the light-emitting unit based on image data. For example, the display apparatus according to the present exemplary embodiment can be a reflection-type liquid crystal display apparatus. Moreover, the display apparatus according to the present exemplary embodiment can be a microelectromechanical system (MEMS) shutter-type display apparatus, which uses MEMS shutters instead of liquid crystal elements.

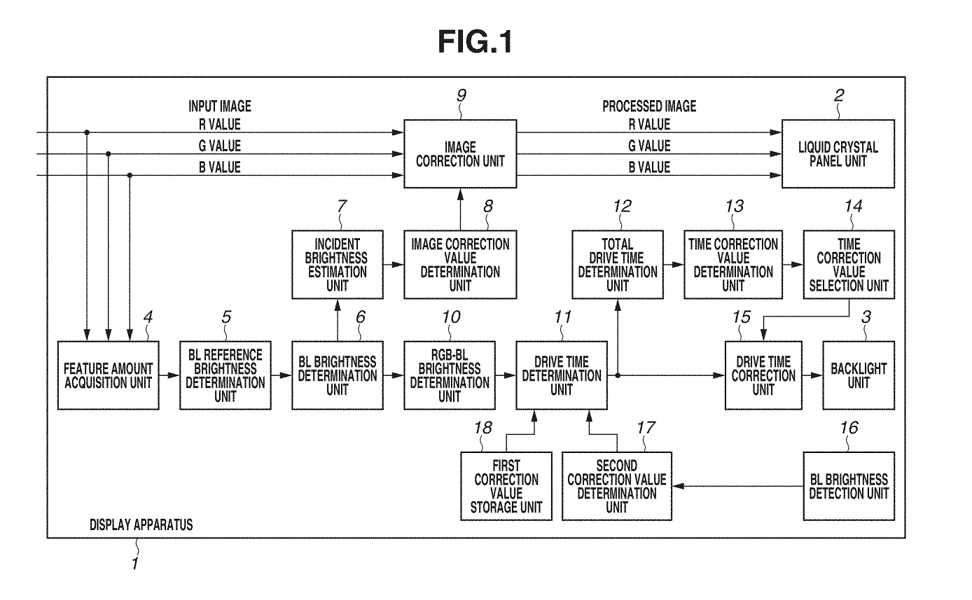

FIG. 1 is a block diagram illustrating a configuration example of a display apparatus 1 according to the present exemplary embodiment. The display apparatus 1, which may include one or more processors, one or more memories, circuitry, or a combination thereof, includes a liquid crystal panel unit 2, a backlight unit 3, a feature amount acquisition unit 4, a backlight (BL) reference brightness determination unit 5, a BL brightness determination unit 6, an incident brightness estimation unit 7, an image correction value determination unit 8, an image correction unit 9, an RGB-BL brightness determination unit 10, and a drive time determination unit 11. Moreover, the display apparatus 1 further includes a total drive time determination unit 12, a time correction value determination unit 13, a time correction value selection unit 14, a drive time correction unit 15, a BL brightness detection unit 16, a second correction value determination unit 17, and a first correction value storage unit 18.

The units described throughout the present disclosure are exemplary and/or preferable modules for implementing processes described in the present disclosure. The modules can be hardware units (such as one or more processors, one or more memories, circuitry, a field programmable gate array, a digital signal processor, an application specific integrated circuit or the like) and/or software modules (such as a computer readable program or the like). The modules for implementing the various steps are not described exhaustively above. However, where there is a step of performing a certain process, there may be a corresponding functional module or unit (implemented by hardware and/or software) for implementing the same process. Technical solutions by all combinations of steps described and units corresponding to these steps are included in the present disclosure.

The liquid crystal panel unit 2 displays an image by modulating light from the backlight unit 3 based on image data. In the present exemplary embodiment, the liquid crystal panel unit 2 includes a liquid crystal driver, a control substrate, and a liquid crystal panel. The liquid crystal panel includes a plurality of liquid crystal elements. The control substrate controls processing performed by the liquid crystal driver based on image data input to the liquid crystal panel unit 2. The liquid crystal driver drives the liquid crystal elements of the liquid crystal panel according to instructions from the control substrate (instructions which are based on image data). With this, control is performed to set the transmittance (aperture ratio or modulation factor) of each liquid crystal element to a value which is based on image data input to the liquid crystal panel unit 2. Light from the backlight unit 3 passes through the liquid crystal elements, so that an image is displayed on the screen.

The backlight unit 3 includes a plurality of light source portions. Each light source portion includes one or more light sources (light-emitting elements). Examples of the light source to be used include a light-emitting diode (LED), an organic electroluminescence (EL) element, and a cold-cathode tube. In the present exemplary embodiment, the backlight unit 3 includes a plurality of light sources, a control circuit which controls light emission of each light source, and an optical unit which diffuses light emitted from each light source. The backlight unit 3 includes, for example, m light source portions in the horizontal direction by n light source portions in the vertical direction. In the present exemplary embodiment, the backlight unit 3 includes, for example, 10 light source portions in the horizontal direction by 6 light source portions in the vertical direction. Moreover, in the present exemplary embodiment, each light source portion includes a plurality of color light source portions having respective different light emission colors. More specifically, each light source portion includes an R light source portion, which is a color light source portion that emits red light, a G light source portion, which is a color light source portion that emits green light, and a B light source portion, which is a color light source portion that emits blue light. Each color light source portion includes one or more light sources. For example, an R-LED which is an LED that emits red light is used as the R light source portion, a G-LED which is an LED that emits green light is used as the G light source portion, and a B-LED which is an LED that emits blue light is used as the B light source portion. In the present exemplary embodiment, a plurality of light source portions, an optical unit, and a liquid crystal panel are arranged in such a manner that red light from the R light source portion, green light from the G light source portion, and blue light from the B light source portion are mixed in color to become white light at the back surface of the liquid crystal panel.

Furthermore, the color light source portions are not limited to the R light source portion, the G light source portion, and the B light source portion. The backlight unit 3 does not need to include at least any one of the R light source portion, the G light source portion, and the B light source portion. The backlight unit 3 can include, for example, a Y light source portion which is a color light source portion that emits yellow light. Furthermore, the arrangement of a plurality of light source portions is not limited to an arrangement in a matrix configuration. For example, a plurality of light source portions can be arranged in a staggered manner.

In the present exemplary embodiment, a plurality of light source portions is respectively associated with a plurality of segmented regions configuring the area of the screen. The feature amount acquisition unit 4 acquires, from input image data, a feature amount in an image region corresponding to a segmented region associated with each of the plurality of light source portions (an image region displayed in the segmented region). Then, the feature amount acquisition unit 4 transmits (outputs) the feature amount acquired with respect to each light source portion to the BL reference brightness determination unit 5. In the present exemplary embodiment, the feature amount acquisition unit 4 acquires the largest value of gradation values in an image region corresponding to a segmented region as a feature amount associated with a light source portion of the segmented region.

Here, a case is considered where RGB image data in which each pixel value is RGB values (a combination of an R value which is a gradation value of red color, a G value which is a gradation value of green color, and a B value which is a gradation value of blue color) is acquired as input image data. In this case, a maximum R value (the largest value of R values) can be acquired as a feature amount, a maximum G value (the largest value of G values) can be acquired as a feature amount, and a maximum B value (the largest value of B values) can be acquired as a feature amount. The largest value of the maximum R value, the maximum G value, and the maximum B value can be acquired as a feature amount. With regard to each pixel, a Y value (brightness value) can be calculated from RGB values. Then, the largest value of Y values can be acquired as a feature amount.

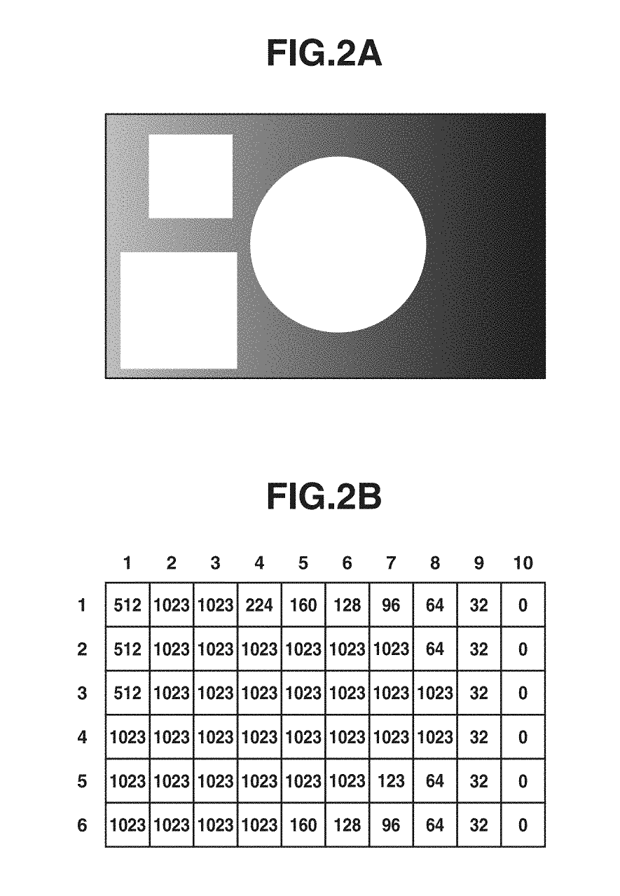

A specific example of processing which is performed by the feature amount acquisition unit 4 is described with reference to FIGS. 2A and 2B. FIG. 2A illustrates an example of input image data. FIG. 2A illustrates an example of a case where gradation values of input image data are 10-bit values (0 to 1023). In FIG. 2A, gradation values are expressed in such a manner that, as the gradation value is larger (as the brightness is higher), the color is closer to white and, as the gradation value is smaller (as the brightness is lower), the color is closer to black. In FIG. 2A, white color corresponds to gradation value “1023”, and black color corresponds to gradation value “0”. In the input image data illustrated in FIG. 2A, three objects each having a gradation value of 1023 (two quadrangular objects and one circular object) are present. Then, in the input image data illustrated in FIG. 2A, the gradation value of the background is gradually changing from “512” to “0” in the direction from left to right.

FIG. 2B illustrates an example of feature amounts acquired with respect to the respective segmented regions (the respective light source portions). FIG. 2B illustrates feature amounts acquired from the image data illustrated in FIG. 2A. In FIG. 2B, numerals (1 to 10) lined up in the horizontal direction indicate respective horizontal positions (positions in the horizontal direction) of the segmented regions, and numerals (1 to 6) lined up in the vertical direction indicate respective vertical positions (positions in the vertical direction) of the segmented regions. As illustrated in FIG. 2B, a segmented region which contains at least a part of the objects has an acquired feature amount (the largest value of gradation values or the maximum gradation value) of 1023. Then, in segmented regions each of which contains no object, the feature amount thereof is gradually changing from “512” to “0” according to an increase of the horizontal position.

Furthermore, a region corresponding to a light source portion (a corresponding region) is not limited to the above-mentioned segmented region. The corresponding region can be separate from another corresponding region, and at least a part of the corresponding region can overlap at least a part of another corresponding region. The correspondence relationship between a corresponding region and a light source does not need to be a correspondence relationship of one to one. For example, two or more light sources can be associated with one corresponding region. The corresponding region can be a part of the area of the screen or can be the whole area of the screen.

Furthermore, the input image data is not limited to RGB image data. For example, YCbCr image data in which each pixel value is YCbCr values (a combination of a Y value which is a brightness value, a Cb value which is a color-difference value, and a Cr value which is a color-difference value) can be acquired as input image data. Moreover, the feature amount is not specifically limited. For example, another representative value of gradation values (for example, a minimum value, an average value, an intermediate value, or a mode (most frequent value)) or a histogram of gradation values can be used as a feature amount. A feature amount which is common between a plurality of light source portions can be acquired. For example, a feature amount corresponding to the whole image region area of input image data can be acquired as the feature amount which is common between a plurality of light source portions.

The BL reference brightness determination unit 5 determines, with respect to each of the plurality of light source portions, a reference brightness serving as a reference for a light emission brightness (a light emission amount) of the light source portion. Then, the BL reference brightness determination unit 5 transmits the reference brightness of each light source portion to the BL brightness determination unit 6. In the present exemplary embodiment, the BL reference brightness determination unit 5 determines, with respect to each of the plurality of light source portions, the reference brightness of the light source portion according to the feature amount acquired with respect to the light source portion.

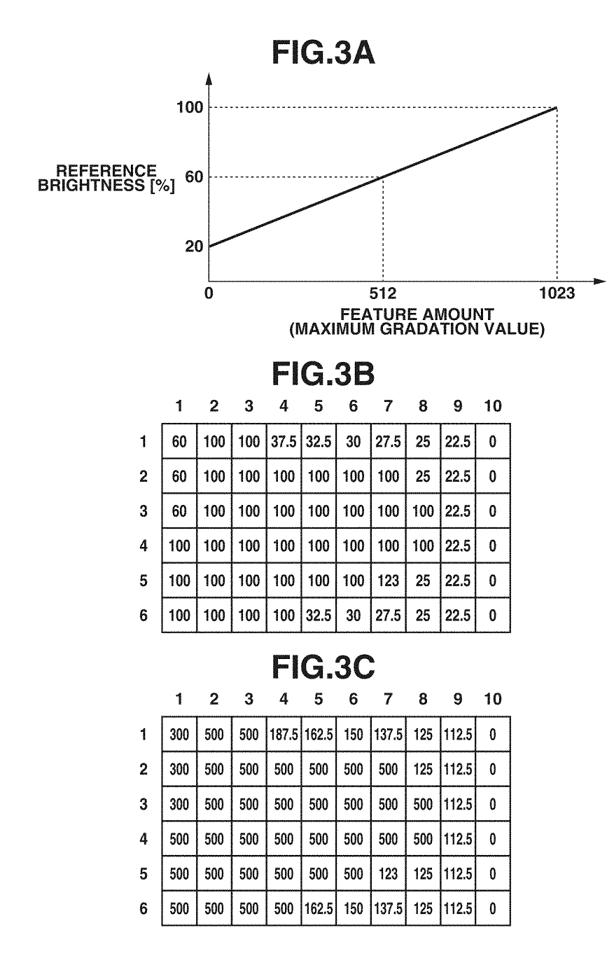

In the present exemplary embodiment, a look-up table (LUT) indicating a correspondence relationship illustrated in FIG. 3A is previously prepared. The correspondence relationship illustrated in FIG. 3A is a correspondence relationship between the feature amount and the reference brightness. The abscissa axis in FIG. 3A indicates the feature amount, and the ordinate axis in FIG. 3A indicates the reference brightness. A reference brightness (light emission brightness) of 0 [%] corresponds to a state in which the light source portion is turned off, and a reference brightness of 100 [%] corresponds to a state in which the light source portion is turned on at the maximum light emission brightness. The BL reference brightness determination unit 5 determines the reference brightness based on the feature amount using the above-mentioned LUT. In a case where feature amounts illustrated in FIG. 2B are acquired, reference brightnesses illustrated in FIG. 3B are determined according to the correspondence relationship illustrated in FIG. 3A.

Furthermore, the method for determining the reference brightness is not limited to the above-mentioned method. For example, a function indicating a correspondence relationship between the feature amount and the reference brightness can be used instead of the LUT. The correspondence relationship between the feature amount and the reference brightness is not limited to the correspondence relationship illustrated in FIG. 3A. The correspondence relationship between the feature amount and the reference brightness is not specifically limited. A predetermined fixed value can be used as a value of the reference brightness.

The BL brightness determination unit 6 determines, with respect to each of the plurality of light source portions, a target brightness serving as a target for the light emission brightness of the light source portion. Thus, the BL brightness determination unit 6 individually determines a target brightness of each light emission portion. Then, the BL brightness determination unit 6 transmits the target brightness of each light emission portion to the incident brightness estimation unit 7 and the RGB-BL brightness determination unit 10. In the present exemplary embodiment, the BL brightness determination unit 6 determines, with respect to each of the plurality of light source portions, a target brightness of the light source portion based on the reference brightness determined with respect to the light source portion and a brightness specified by the user (a user-specified brightness). The user can specify a display brightness (the brightness of a screen) by performing an operation using, for example, a setting image displayed on the screen. In the present exemplary embodiment, the upper limit of display brightness (a display brightness corresponding to the upper limit of gradation values) is specified by the user. Furthermore, the user-specified brightness is not limited to the upper limit of display brightness. For example, a display brightness corresponding to another gradation value smaller than the upper limit of gradation values can be specified by the user. Moreover, the method for determining the target brightness is not specifically limited. For example, the reference brightness can also be used as the target brightness.

The target brightness is calculated by using, for example, the following formula (1). In formula (1), “maximum transmittance” is the upper limit of transmittance of the liquid crystal panel.

Target brightness=(User-specified brightness/Maximum transmittance)×Reference brightness (1)

Although the maximum transmittance is not specifically limited, a case is considered where the maximum transmittance is 10 [%]. Then, a case is considered where the user-specified brightness is 200 [cd/m²] and the reference brightness is 100 [%]. In this case, a target brightness of 2000 [cd/m²] is obtained using formula (1). A case is considered where the maximum transmittance is 10 [%], the user-specified brightness is 1000 [cd/m²], and the reference brightness is 100 [%]. In this case, a target brightness of 10000 [cd/m²] is obtained using formula (1). A case is considered where the maximum transmittance is 10 [%], the user-specified brightness is 1000 [cd/m²], and the reference brightness is 80 [%]. In this case, a target brightness of 8000 [cd/m²] is obtained using formula (1).

Here, a case is considered where light from a light source portion leaks out to a surrounding area of the light source portion. For example, in a case where the backlight unit 3 is a backlight unit of the direct type, the above-mentioned leakage occurs. In this case, it is desirable to determine the target brightness in consideration of the above-mentioned leakage. The method for determining the target brightness in consideration of the above-mentioned leakage (leakage of light (light from a light source portion) in a space between segmented regions) includes various methods heretofore proposed. For example, a method for determining the target brightness in consideration of the above-mentioned leakage is discussed in Japanese Patent Application Laid-Open No. 2014-44302. A specific example in which the method discussed in Japanese Patent Application Laid-Open No. 2014-44302 is used is described as follows.

First, the target brightness of each light source portion is provisionally determined in such a manner that the target brightness of a light source portion with a reference brightness of 100 [%] becomes 100 [cd/m²] and target brightnesses are proportional to reference brightnesses. After that, with respect to each of the plurality of segmented regions, an incident brightness (a brightness of light incident on the liquid crystal panel) of light emitted from the backlight unit 3 (a plurality of light source portions) is estimated in consideration of the above-mentioned leakage. Then, in a case where there is a segmented region in which the estimated incident brightness is lower than a desired brightness (for example, a brightness obtained from the left-hand side of formula (1)), the target brightness of each light source portion is increased at the same increase rate in such a manner that the incident brightness becomes equal to or higher than the desired brightness with respect to all of the segmented regions.

In the present exemplary embodiment, an estimation position serving as a target for estimation of the incident brightness is previously defined with respect to each of the plurality of segmented regions. While the estimation position is not specifically limited, for example, with respect to each of the plurality of segmented regions, the center location of the segmented region is previously defined as the estimation position. Therefore, there is a plurality of combinations of the light source portion and the estimation position. Then, an attenuation coefficient is previously defined with respect to each of the plurality of combinations. The attenuation coefficient is the degree of attenuation occurring until light emitted from a light source portion corresponding to the attenuation coefficient arrives at an estimation position corresponding to the attenuation coefficient.

In the present exemplary embodiment, with respect to each of a plurality of estimation positions, the following processing is performed. This enables estimating a plurality of incident brightnesses respectively corresponding to the plurality of segmented regions. First, processing for multiplying a target brightness by an attenuation coefficient corresponding to an estimation position of the processing target is performed with respect to each light source portion. Next, the sum of multiplication results obtained with respect to the respective light source portions is calculated as an incident brightness in the estimation position of the processing target.

FIG. 3C illustrates an example of target brightnesses determined in the above-described method. FIG. 3C illustrates a case where the maximum transmittance is 100 [%] and the user-specified brightness is 1000 [cd/m²]. In FIG. 3C, a target brightness of 500 [cd/m²], which is lower than the user-specified brightness of 1000 [cd/m²], is associated with each segmented region with a reference brightness of 100 [%] illustrated in FIG. 3B. This is because light with a brightness of 500 [cd/m²] or more in total leaks out from a surrounding area of the above-mentioned segmented region. Leakage of light from a surrounding area can also occur with respect to another segmented region. Therefore, in FIG. 3C, a target brightness which is lower than a brightness obtained by multiplying the user-specified brightness of 1000 [cd/m²] by a reference brightness illustrated in FIG. 3B (a brightness obtained from the left-hand side of formula (1)) is also associated with another segmented region.

The incident brightness estimation unit 7 estimates a plurality of incident brightnesses respectively corresponding to a plurality of estimation positions based on the target brightness of each light source portion. Then, the incident brightness estimation unit 7 transmits the incident brightnesses of the respective estimation positions to the image correction value determination unit 8. The method for estimating the incident brightness is as described above. For example, the shape of a segmented region and the estimation position are not specifically limited. In the present exemplary embodiment, the shape of each segmented region is quadrangular. Then, in the present exemplary embodiment, the incident brightness estimation unit 7 uses, as an estimation position, each of a plurality of positions including the positions of four corners of each segmented region and the central locations of sides of each segmented region.

The image correction value determination unit 8 determines, with respect to each of a plurality of estimation positions used by the incident brightness estimation unit 7, a correction value used to correct image data based on the estimated incident brightness. Then, the image correction value determination unit 8 outputs the correction value for each estimation position to the image correction unit 9. In a display apparatus, there are needs to “want to accurately display a brightness corresponding to input image data”. When the incident brightness changes from a predetermined brightness, the display brightness also changes. Therefore, for example, a value used to reduce a change of the display brightness corresponding to a change of the incident brightness from the predetermined brightness is determined as the correction value. In the present exemplary embodiment, the following formula (2) is used to calculate, as the correction value, a correction coefficient Gpn which is a gain value to be multiplied by a gradation value of image data. In formula (2), “Lt” denotes the above-mentioned predetermined brightness, and “Lpn” denotes the estimated incident brightness. The predetermined brightness Lt is, for example, a brightness proportional to the user-specified brightness. Furthermore, the correction value is not limited to a gain value. For example, an offset value to be added to a gradation value of image data can be determined as the correction value.

Gpn=Lt/Lpn (2)

The image correction unit 9 corrects each gradation value of input image data using the correction value determined by the image correction value determination unit 8, thus generating processed image data. Then, the image correction unit 9 outputs the processed image data to the liquid crystal panel unit 2. More specifically, with regard to an estimation position used by the incident brightness estimation unit 7, the correction coefficient Gpn determined by the image correction value determination unit 8 is multiplied by a gradation value of input image data. With regard to a position different from the estimation position used by the incident brightness estimation unit 7, a correction coefficient is determined by interpolation processing using a plurality of correction coefficients Gpn determined with respect to a plurality of estimation positions surrounding the position. Then, the determined correction coefficient is multiplied by a gradation value of input image data.

The RGB-BL brightness determination unit 10 individually determines, with respect to each of the plurality of light source portions, a target brightness of an R light source portion included in the light source portion, a target brightness of a G light source portion included in the light source portion, and a target brightness of a B light source portion included in the light source portion based on a target brightness of the light source portion. “Processing for determining a plurality of target brightnesses respectively corresponding to a plurality of color light source portions based on a target brightness of a light source portion” can be said to be “processing for dividing a target brightness of a light source portion into a plurality of target brightnesses respectively corresponding to a plurality of color light source portions”. Then, the RGB-BL brightness determination unit 10 transmits the target brightnesses of the respective color light source portions to the drive time determination unit 11.

In the present exemplary embodiment, as a ratio at which to irradiate the back surface of the liquid crystal panel with white light, the light emission brightness of an R light source portion:the light emission brightness of a G light source portion:the light emission brightness of a B light source portion=3:6:1 is previously defined. Then, the RGB-BL brightness determination unit 10 calculates, with respect to each of a plurality of light source portions, the target brightness of an R light source portion, the target brightness of a G light source portion, and the target brightness of a B light source portion using the following formulae (3-1) to (3-3). In a case where the target brightness of the light source portion is 500 [cd/m²], a target brightness of 150 [cd/m²] of the R light source portion, a target brightness of 300 [cd/m²] of the G light source portion, and a target brightness of 50 [cd/m²] of the B light source portion are calculated using formulae (3-1) to (3-3). Furthermore, the ratio is not limited to 3:6:1.

Target brightness of R light source portion=Target brightness of light source portion×3/(3+6+1) (3-1)

Target brightness of G light source portion=Target brightness of light source portion×6/(3+6+1) (3-2)

Target brightness of B light source portion=Target brightness of light source portion×1/(3+6+1) (3-3)

The drive time determination unit 11 performs drive value determination processing with respect to each color light source portion. The drive value determination processing for a color light source portion is “processing for determining a drive value which is a value used to perform control to set the light emission brightness of a color light source portion to a target brightness based on the target brightness of the color light source portion and which is a value regarding a drive time of the color light source portion”. The drive value determination processing can also be said to be “processing for determining a drive time”. The drive time determination unit 11 transmits the determined drive value to the total drive time determination unit 12 and the drive time correction unit 15.

In the present exemplary embodiment, the drive time determination unit 11 determines a drive value for each color light source portion in consideration of the luminous efficiency of each color light source portion. More specifically, “processing for determining a drive value for the color light source portion based on the following three factors 1 to 3” is performed as the drive value determination processing.

Factor 1: Target brightness of the color light source portion
Factor 2: Correspondence relationship between the light emission brightness of the color light source portion and the drive value for the color light source portion in a case where the luminous efficiency of the color light source portion is a reference luminous efficiency
Factor 3: Difference between the luminous efficiency of the color light source portion and the reference luminous efficiency

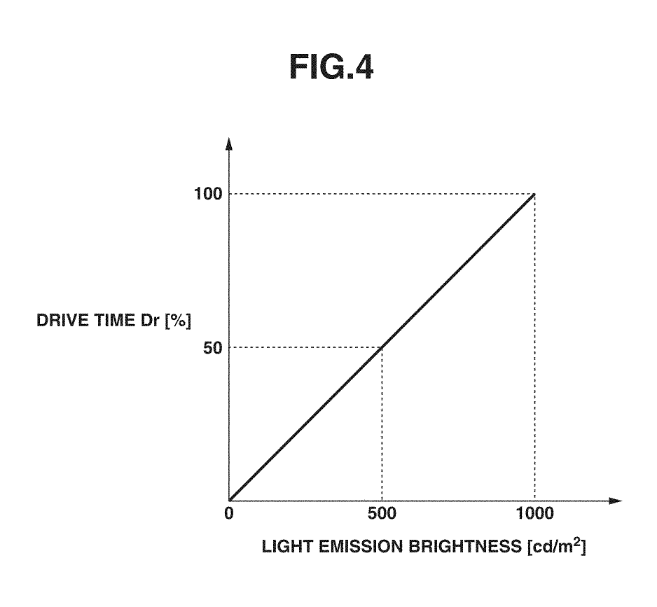

The “correspondence relationship between the light emission brightness of the color light source portion and the drive value for the color light source portion in a case where the luminous efficiency of the color light source portion is a reference luminous efficiency” can also be said to be a “correspondence relationship between the light emission brightness of the color light source portion and the drive time of the color light source portion in a case where the luminous efficiency of the color light source portion is a reference luminous efficiency”. This correspondence relationship is not specifically limited, but, in the present exemplary embodiment, a correspondence relationship illustrated in FIG. 4 is used. The abscissa axis in FIG. 4 indicates the light emission brightness of the color light source portion, and the ordinate axis in FIG. 4 indicates a drive time of the color light source portion. A thick solid line illustrated in FIG. 4 indicates a correspondence relationship in a case where the luminous efficiency of the color light source portion is the reference luminous efficiency. The value of the drive time in FIG. 4 is a normalized value. A drive time of 100 [%] corresponds to a state in which the color light source portion continues being turned on for a period of one frame. Actually, a reset period for a light source driver (a control circuit which controls light emission of each light source) may be used. Therefore, in a case where the length of a period of one frame is 16.6 [msec], a drive time of 100 [%] corresponds to a time equal to or shorter than 16.6 [msec]. The drive time is equivalent to a proportion of the turning-on period of the light source portion to the period of one frame. Each light source portion is subjected to pulse width modulation (PWM) control, and the turning-on period and turning-off period thereof are adaptively controlled in each frame period.

As the “difference between the luminous efficiency of the color light source portion and the reference luminous efficiency”, there can be the following three differences 1 to 3. In the present exemplary embodiment, all of the differences 1 to 3 are taken into consideration. Furthermore, one or two of the differences 1 to 3 do not need to be taken into consideration. For example, only the difference 1 can be taken into consideration, or only the differences 2 and 3 can be taken into consideration.

Difference 1: Difference caused during manufacturing of the color light source portion
Difference 2: Difference caused by a temperature change of the color light source portion
Difference 3: Difference caused by an aged deterioration of the color light source portion

In the present exemplary embodiment, a first correction value Ch(c, x, y) used to reduce a brightness change (a change in light emission brightness from the target brightness) caused by the above difference 1 is previously recorded on the first correction value storage unit 18. The first correction value Ch(c, x, y) is a correction value for a color light source portion which is included in a light source portion located in position (horizontal position, vertical position)=(x, y) and the light emission color of which is color c. Furthermore, in the present exemplary embodiment, a second correction value Cd(c, x, y) used to reduce a brightness change (a change in light emission brightness from the target brightness) caused by the above difference 2 or 3 is determined by the second correction value determination unit 17. The second correction value Cd(c, x, y) is a correction value for a color light source portion which is included in a light source portion located in position (x, y) and the light emission color of which is color c.

In the present exemplary embodiment, the drive time determination unit 11 acquires a drive time Dr(c, x, y)=f(L(c, x, y)) corresponding to a target brightness L(c, x, y) of the color light source portion from the correspondence relationship illustrated in FIG. 4 (for example, an LUT indicating the correspondence relationship illustrated in FIG. 4 or a function indicating the correspondence relationship illustrated in FIG. 4). Moreover, the drive time determination unit 11 acquires the first correction value Ch(c, x, y) from the first correction value storage unit 18 and acquires the second correction value Cd(c, x, y) from the second correction value determination unit 17. Then, the drive time determination unit 11 calculates a drive time RDr(c, x, y) of the color light source portion from the drive time Dr(c, x, y), the first correction value Ch(c, x, y), and the second correction value Cd(c, x, y) using the following formula (4). In the present exemplary embodiment, the drive time determination unit 11 transmits the drive time RDr(c, x, y) as a drive value.

RDr(c,x,y)=Dr(c,x,y)×Ch(c,x,y)×Cd(c,x,y) (4)

The above-described processing is individually performed with respect to each color light source portion. Hereinafter, the drive time RDr(c, x, y) of an R light source portion included in a light source portion located in position (x, y) is referred to as a “drive time RDrr(x, y)”. The drive time RDr(c, x, y) of a G light source portion included in the light source portion located in position (x, y) is referred to as a “drive time RDrg(x, y)”. Then, the drive time RDr(c, x, y) of a B light source portion included in the light source portion located in position (x, y) is referred to as a “drive time RDrb(x, y)”.

Furthermore, a value different from the value of a drive time can be used as a drive value. For example, another value proportional to the drive time can be used as a drive value. More specifically, for example, in a case where a color light source portion is driven in a pulse width modulation method, a value proportional to the drive time is used as a control value used to control processing to be performed by a light source driver. In such a case, the control value for the light source driver can be used as a drive value.

The total drive time determination unit 12 determines a total drive time based on drive values for the respective color light source portions (the drive values determined by the drive time determination unit 11), and transmits the determined total drive time to the time correction value determination unit 13. In the present exemplary embodiment, the total drive time is the sum of a plurality of drive times respectively corresponding to a plurality of color light source portions having the same light emission color. Moreover, in the present exemplary embodiment, the total drive time determination unit 12 determines a total drive time with respect to each of a plurality of light emission colors. More specifically, the total drive time determination unit 12 determines a total drive time which is the sum of a plurality of drive times respectively corresponding to a plurality of R light source portions based on drive values for the respective R light source portions. The total drive time determination unit 12 determines a total drive time which is the sum of a plurality of drive times respectively corresponding to a plurality of G light source portions based on drive values for the respective G light source portions. Then, the total drive time determination unit 12 determines a total drive time which is the sum of a plurality of drive times respectively corresponding to a plurality of B light source portions based on drive values for the respective B light source portions.

The time correction value determination unit 13 determines a time correction value used to correct the drive value (the drive value determined by the drive time determination unit 11) of each color light source portion, and transmits the determined time correction value to the time correction value selection unit 14. The time correction value can be said to be a “correction value used to correct the drive time”. More specifically, the time correction value determination unit 13 performs, with respect to each of a plurality of light emission colors, processing for comparing the total drive time determined by the total drive time determination unit 12 with a threshold value and then determining a time correction value based on a result of the comparison. In the present exemplary embodiment, with respect to a light emission color for which the total drive time is longer than the threshold value, a time correction value used to limit the total drive time to a time equal to or shorter than the threshold value is determined. A specific example of the processing performed by the time correction value determination unit 13 is described as follows.

An amount of current IR(x, y) to be supplied to the R light source portion, an amount of current IG(x, y) to be supplied to the G light source portion, and an amount of current IB(x, y) to be supplied to the B light source portion are expressed by the following formulae (5-1) to (5-3). In formulae (5-1) to (5-3), “Ir” denotes a time average of the amount of current to be supplied to the R light source portion, “Ig” denotes a time average of the amount of current to be supplied to the G light source portion, and “Ib” denotes a time average of the amount of current to be supplied to the B light source portion. The “time average of the amount of current to be supplied to a color light source portion” is, for example, a “time average of the amount of current to be supplied to a color light source portion in a case where the color light source portion continues being turned on for a period of one frame”.

IR(x,y)=Ir×RDrr(x,y) (5-1)

IG(x,y)=Ig×RDrg(x,y) (5-2)

IB(x,y)=Ib×RDrb(x,y) (5-3)

Then, the sum SR of the amounts of current IR(x, y) to be supplied to the respective R light source portions, the sum SG of the amounts of current IG(x, y) to be supplied to the respective G light source portions, and the sum SB of the amounts of current IB(x, y) to be supplied to the respective B light source portions are expressed by the following formulae (6-1) to (6-3).

$$\begin{matrix}\begin{matrix}SR = \sum IR ( x , y ) \\ = \sum ( Ir \times RDrr ( x , y ) ) \\ = Ir \times \sum RDrr ( x , y )\end{matrix} & ( 6 - 1 ) \\ \begin{matrix}SG = \sum IG ( x , y ) \\ = \sum ( Ig \times RDrg ( x , y ) ) \\ = Ig \times \sum RDrg ( x , y )\end{matrix} & ( 6 - 2 ) \\ \begin{matrix}SB = \sum IB ( x , y ) \\ = \sum ( Ib \times RDrb ( x , y ) ) \\ = Ib \times \sum RDrb ( x , y )\end{matrix} & ( 6 - 3 )\end{matrix}$$

ΣRDrr(x, y) in formula (6-1) denotes a total drive time of a plurality of R light source portions, ΣRDrg(x, y) in formula (6-2) denotes a total drive time of a plurality of G light source portions, and ΣRDrb(x, y) in formula (6-3) denotes a total drive time of a plurality of B light source portions. Therefore, threshold values ΣRDrr(x, y)max, ΣRDrg(x, y)max, and ΣRDrb(x, y)max to be compared with the respective total drive times can be obtained according to the following formulae (7-1) to (7-3). In formulae (7-1) to (7-3), “SRmax” denotes the upper limit of the sum of the amounts of current to be supplied to the respective R light source portions, “SGmax” denotes the upper limit of the sum of the amounts of current to be supplied to the respective G light source portions, and “SBmax” denotes the upper limit of the sum of the amounts of current to be supplied to the respective B light source portions. “ΣRDrr(x, y)max” denotes a threshold value to be compared with the total drive time of a plurality of R light source portions. “ΣRDrg(x, y)max” denotes a threshold value to be compared with the total drive time of a plurality of G light source portions. Then, “ΣRDrb(x, y)max” denotes a threshold value to be compared with the total drive time of a plurality of B light source portions.

ΣRDrr(x,y)max=SRmax/Ir (7-1)

ΣRDrg(x,y)max=SGmax/Ig (7-2)

ΣRDrb(x,y)max=SBmax/Ib (7-3)

The amounts of current SRmax, SGmax, and SBmax are determined according to, for example, the performance of a power source which supplies electric power to the display apparatus 1 or the performance of the display apparatus 1 (for example, a power-supply circuit of the display apparatus 1). Therefore, it can also be said that “the threshold values ΣRDrr(x, y)max, ΣRDrg(x, y)max, and ΣRDrb(x, y)max are determined by, for example, the above-mentioned performance”.

Even when the upper limit of the amount of current which the power source is able to output is the same between a plurality of light emission colors, usually, voltages to be applied to the respective color light source portions differ between a plurality of light emission colors. Moreover, usually, the amounts of electric power for the respective color light source portions to irradiate the back surface of a liquid crystal panel with white light also differ between a plurality of light emission colors. Therefore, the amount of current SRmax, the amount of current SGmax, and the amount of current SBmax differ from one another, and the threshold value ΣRDrr(x, y)max, the threshold value ΣRDrg(x, y)max, and the threshold value ΣRDrb(x, y)max differ from one another.

Furthermore, according to each of formulae (7-1) to (7-3), the upper limit of the total drive time is obtained as a threshold value. However, a time different from the upper limit of the total drive time can be used as a threshold value. For example, a time shorter than the upper limit of the total drive time can be used as a threshold value. Moreover, a threshold value in common between a plurality of light emission colors can also be used.

In the present exemplary embodiment, the time correction value determination unit 13 calculates time correction values GainR, GainG, and GainB using the following formulae (8-1) to (8-3). According to formulae (8-1) to (8-3), the time correction values GainR, GainG, and GainB are calculated by dividing the threshold values respectively by the total drive times. Therefore, each of the time correction values GainR, GainG, and GainB is a proportion of the threshold value to the total drive time.

GainR=ΣRDrr(x,y)max/ΣRDrr(x,y) (8-1)

GainG=ΣRDrg(x,y)max/ΣRDrg(x,y) (8-2)

GainB=ΣRDrb(x,y)max/ΣRDrb(x,y) (8-3)

The time correction value GainR is a time correction value used to correct the drive value (drive time) for each R light source portion, the time correction value GainG is a time correction value used to correct the drive value for each G light source portion, and the time correction value GainB is a time correction value used to correct the drive value for each B light source portion. More specifically, the time correction value GainR is a gain value by which to multiply the drive value for each R light source portion, the time correction value GainG is a gain value by which to multiply the drive value for each G light source portion, and the time correction value GainB is a gain value by which to multiply the drive value for each B light source portion. With respect to a light emission color for which the total drive time is longer than a threshold value, each drive value is multiplied by the time correction value, so that the total drive time can be limited to the threshold value.

The time correction value determination unit 13 outputs the time correction values GainR, GainG, and GainB calculated by using formulae (8-1) to (8-3). However, in the case of “ΣRDrr(x, y)<ΣRDrr(x, y)max”, the time correction value determination unit 13 outputs the time correction value GainR=1. In the case of “ΣRDrg(x, y) ΣRDrg(x, y)max”, the time correction value determination unit 13 outputs the time correction value GainG=1. Then, in the case of “ΣRDrb(x, y)<ΣRDrb(x, y)max”, the time correction value determination unit 13 outputs the time correction value GainB=1.

Furthermore, the time correction value is not limited to the above-mentioned value. A value different from the proportion of the threshold value to the total drive time can also be determined as a time correction value. A time correction value used to limit the total drive time to a time shorter than the threshold value can also be determined. An offset value to be added to each drive value can also be determined as a time correction value.

The time correction value selection unit 14 selects any one of the time correction value GainR, the time correction value GainG, and the time correction value GainB as a correction value to be used to correct each drive value (the drive value for each R light source portion, the drive value for each G light source portion, and the drive value for each B light source portion). In the present exemplary embodiment, the time correction value selection unit 14 selects the smallest value of the time correction value GainR, the time correction value GainG, and the time correction value GainB. Then, the time correction value selection unit 14 transmits the selected time correction value to the drive time correction unit 15.

In a case where correction is performed using time correction values different between a plurality of light emission colors, correction to each drive value may cause the ratio (the light emission brightness of the R light source portion:the light emission brightness of the G light source portion:the light emission brightness of the B light source portion) to be changed from the ratio at which to irradiate the back surface of a liquid crystal panel with white light. Since any one of the time correction value GainR, the time correction value GainG, and the time correction value GainB is selected to be used for correction, such a change of the ratio can be prevented. Furthermore, in a case where correction is performed using a time correction value larger than the smallest value of the time correction value GainR, the time correction value GainG, and the time correction value GainB, even if each drive value is corrected, a light emission color for which the total drive time is longer than the threshold value may remain. Since the smallest value of the time correction value GainR, the time correction value GainG, and the time correction value GainB is selected to be used for correction, the total drive time of each light emission color can be surely limited to a value equal to or less than the threshold value.

Furthermore, the method for selecting (the method for determining) a time correction value used to correct each drive value is not limited to the above-mentioned method. For example, the time correction value selection unit 14 can select the largest value of the time correction value GainR, the time correction value GainG, and the time correction value GainB as a time correction value to be used for correction of each drive value. The time correction value selection unit 14 can select the second largest value of the time correction value GainR, the time correction value GainG, and the time correction value GainB as a time correction value to be used for correction of each drive value. The time correction value selection unit 14 can select another representative value (for example, an average value, an intermediate value, or a mode (most frequent value)) of the time correction value GainR, the time correction value GainG, and the time correction value GainB as a time correction value to be used for correction of each drive value. The time correction value selection unit 14 can select the time correction value GainR as a time correction value to be used for correction of the drive value for each R light source portion. The time correction value selection unit 14 can select the time correction value GainG as a time correction value to be used for correction of the drive value for each G light source portion. The time correction value selection unit 14 can select the time correction value GainB as a time correction value to be used for correction of the drive value for each B light source portion.

The drive time correction unit 15 corrects each drive value transmitted from the drive time determination unit 11 using the time correction value transmitted from the time correction value selection unit 14. In the present exemplary embodiment, the drive time correction unit 15 multiplies each drive value transmitted from the drive time determination unit 11 by the time correction value transmitted from the time correction value selection unit 14. With this, each drive value transmitted from the drive time determination unit 11 is corrected. Then, the drive time correction unit 15 outputs each corrected drive value to the backlight unit 3. With this, each color light source portion of the backlight unit 3 performs light emission according to the corrected drive value.

Furthermore, the time correction value determination unit 13 can determine a time correction value only with respect to a light emission color for which the total drive time determined by the total drive time determination unit 12 is longer than the threshold value. Then, the drive time correction unit 15 can omit correction to each drive value in a case where there is no light emission color for which the total drive time is longer than the threshold value.

The BL brightness detection unit 16 is a brightness sensor which detects the brightness (the brightness distribution or the light emission brightness of each light source portion) of light emitted from the backlight unit 3. The BL brightness detection unit 16 transmits a result of detection of the light emitted from the backlight unit 3 to the second correction value determination unit 17. In the present exemplary embodiment, the BL brightness detection unit 16 detects a brightness with respect to each of a plurality of light emission colors. Thus, the BL brightness detection unit 16 detects the light emission brightness of each color light source portion. The brightness detection by the BL brightness detection unit 16 is performed so as to detect a change in luminous efficiency of each color light source portion. Therefore, the brightness detection by the BL brightness detection unit 16 is performed with the drive condition (drive time) of each color light source portion kept the same. Furthermore, as long as a brightness corresponding to a predetermined drive time can be detected, the method for brightness detection is not specifically limited. For example, when a time-integrated value is obtained as a detection value for brightness, a brightness corresponding to a unit time can be obtained from the obtained detection value.

The second correction value determination unit 17 determines a second correction value based on a result of detection transmitted from the BL brightness detection unit 16, and transmits the determined second correction value to the drive time determination unit 11. For example, the second correction value determination unit 17 previously stores the value of a brightness corresponding to a reference luminous efficiency (an initial brightness). Then, the second correction value determination unit 17 performs, with respect to each color light source portion, processing for comparing the detected brightness with the initial brightness and determining a second correction value used to correct the drive time in such a way as to bring the detected brightness close to the initial brightness based on a result of the comparison. More specifically, in a case where the detected brightness is lower by 5 [%] than the initial brightness, a second correction value used to lengthen the drive time by 5 [%] is determined.

As described above, according to the present exemplary embodiment, a drive value for each light source portion is corrected based on the respective drive values for a plurality of light source portions in such a manner that, in a case where a total drive time which is the sum of a plurality of drive times respectively corresponding to the plurality of light source portions is greater than a threshold value, the total drive time becomes equal to or less than the threshold value. With this, irrespective of whether the drive value has been determined in consideration of the luminous efficiency of each light source portion, displaying with electric power efficiently used can be performed. For example, in a case where the total drive time is longer than the threshold value, the drive value for each light source portion can be corrected in such a manner that the total drive time approximately coincides with the threshold value. As a result, displaying with electric power maximally used can be performed. The details of the first exemplary embodiment are as described above. With the above-described configuration, the actual drive time of each element obtained in consideration of a variation of the luminous efficiency of each element and a thermal or temporal deterioration in luminous efficiency is calculated, so that the accurate total drive time is obtained. With this, displaying can be performed at the end of a constrained condition for the power source, so that displaying with a high use efficiency of the power source can be performed.

Furthermore, in the present exemplary embodiment, an example in which each light source portion includes a plurality of types of color light source portions has been described. However, each light source portion does not need to include a plurality of types of color light source portions. For example, each light source portion can include only one or more while light sources (light sources which emit white light). In that case, the above-mentioned processing with respect to color light source portions can be performed as processing with respect to a light source portion. Moreover, in that case, processing by the RGB-BL brightness determination unit 10 and processing by the time correction value selection unit 14 are omitted.

Furthermore, a plurality of light source portions may be sectioned into two or more partial light emission portions, and two or more power sources (two or more power-supply circuits) respectively corresponding to two or more partial light emission portions may be used. Each partial light emission portion includes one or more light source portions. For example, in a case where the screen size is large, a plurality of power sources respectively corresponding to a plurality of partial light emission portions may be used. More specifically, a plurality of regions respectively corresponding to a plurality of partial light emission portions may be previously set as a plurality of partial regions configuring the region of the screen, and a plurality of power sources respectively corresponding to the plurality of partial regions may be used. The plurality of partial regions can be set as, for example, two regions arranged vertically side by side, two regions arranged horizontally side by side, and four regions arranged two rows by two columns. In that case, a time correction value can be individually determined with respect to each partial light emission portion, and a time correction value used to correct each drive value can be determined based on a plurality of time correction values respectively corresponding to the plurality of partial light emission portions. For example, the smallest value of a plurality of time correction values respectively corresponding to the plurality of partial light emission portions can be selected as a time correction value used to correct each drive value.

A second exemplary embodiment of the present disclosure is described as follows. Furthermore, in the following description, portions (for example, a configuration and processing) different from those in the first exemplary embodiment are described in detail, and portions similar to those in the first exemplary embodiment are omitted from description. In the present exemplary embodiment, an example in which a display apparatus has a plurality of operation modes including a first mode and a second mode, in which a current value to be supplied to each color light source portion is larger than in the first mode is described.

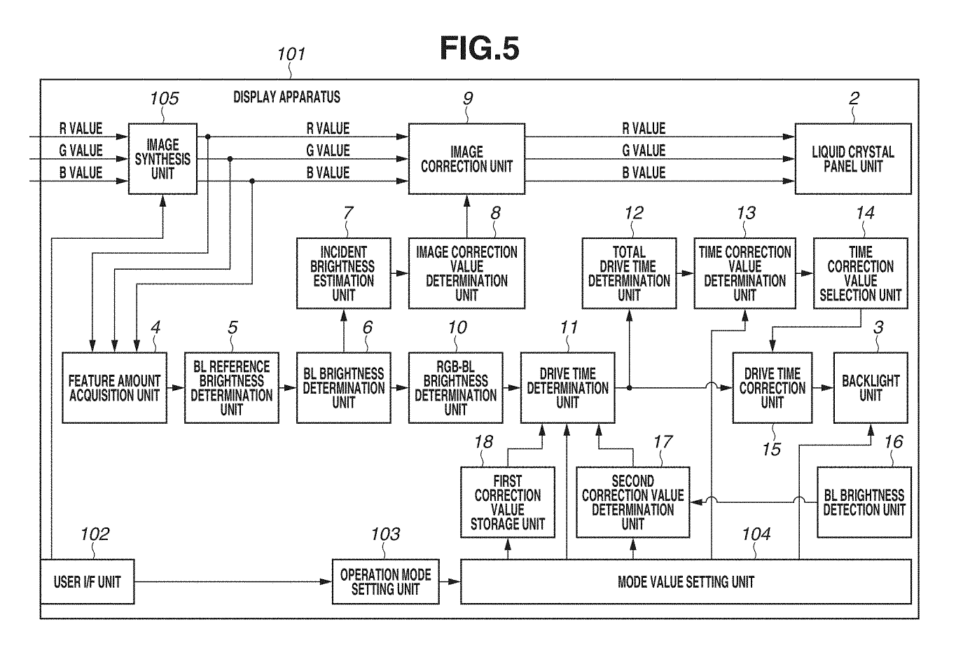

FIG. 5 is a block diagram illustrating a configuration example of a display apparatus 101 according to the present exemplary embodiment. In FIG. 5, functional units similar to those of the first exemplary embodiment (FIG. 1) are assigned the respective same reference numerals as those in the first exemplary embodiment. As illustrated in FIG. 5, the display apparatus 101 includes the functional units of the display apparatus 1 in the first exemplary embodiment, a user interface (I/F) unit 102, an operation mode setting unit 103, a mode value setting unit 104, and an image synthesis unit 105.

The image synthesis unit 105 acquires input image data. Then, the image synthesis unit 105 combines the input image data with graphic image data to generate composite image data, and outputs the composite image data to the feature amount acquisition unit 4 and the image correction unit 9. The composite image data represents, for example, a composite image in which an input image represented by the input image data and a graphic image represented by the graphic image data are arranged. In the present exemplary embodiment, the image synthesis unit 105 generates composite image data representing a composite image in which an input image and a graphic image are arranged, according to a display instruction from the user I/F unit 102, and outputs the composite image data.

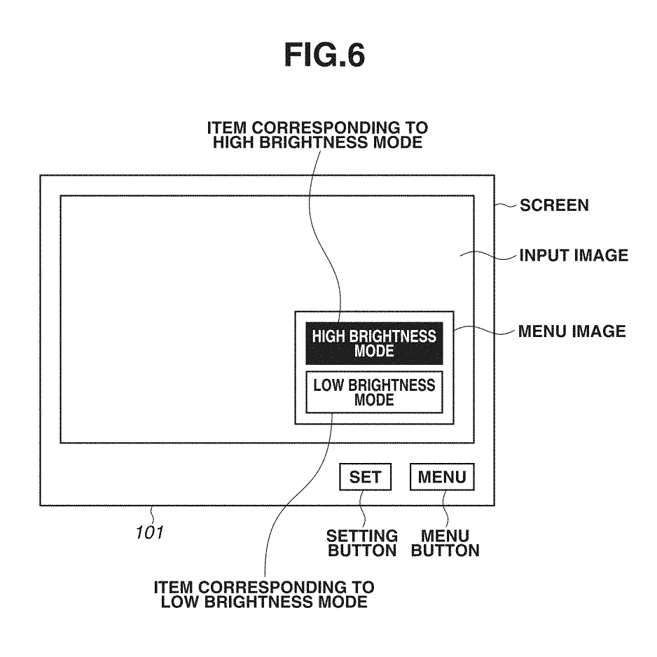

The graphic image is not specifically limited. In the present exemplary embodiment, the graphic image is a menu image via which to allow the user to select any one of a plurality of operation modes. More specifically, the graphic image is a menu image having a plurality of items respectively corresponding to a plurality of operation modes. FIG. 6 illustrates an example of a composite image. In the composite image illustrated in FIG. 6, a menu image is superimposed on a partial image region of an input image. The menu image illustrated in FIG. 6 has an item corresponding to a high brightness mode and an item corresponding to a low brightness mode. In the high brightness mode, the display brightness is higher than in the low brightness mode, and a current value to be supplied to each color light source portion is larger than in the low brightness mode. Furthermore, the number of operation modes can be greater than two. The operation modes do not need to include at least one of the high brightness mode and the low brightness mode.

Furthermore, the image synthesis unit 105 can output the input image data without outputting the composite image data. For example, in a period before the display instruction is issued, the image synthesis unit 105 outputs the input image data to the feature amount acquisition unit 4 and the image correction unit 9. Moreover, the image synthesis unit 105 switches image data to be output from the composite image data to the input image data according to an erasing instruction from the user I/F unit 102.

The user I/F unit 102 is an interface capable of receiving a user operation (an operation performed on the display apparatus 101 by the user). In response to a user operation being performed, the user I/F unit 102 outputs a signal (an instruction) corresponding to the user operation performed. In the present exemplary embodiment, in response to a user operation (a display operation) to display a menu image, the user I/F unit 102 outputs a display instruction to the image synthesis unit 105. In response to a user operation (an erasing operation) to erase a menu image, the user I/F unit 102 outputs an erasing instruction to the image synthesis unit 105. In response to a setting operation to set an operation mode, the user I/F unit 102 outputs a setting instruction to the operation mode setting unit 103.

The user operation is not specifically limited. In the present exemplary embodiment, as illustrated in FIG. 6, the display apparatus 101 has a menu button and a setting button. The display operation is a user operation which presses the menu button, and the erasing operation is a user operation which presses the menu button next to the display operation. The setting operation is a user operation which presses the setting button with any one of the plurality of items of the menu image selected by the user. The setting instruction is an instruction regarding an item (an operation mode) selected by the user.

The operation mode setting unit 103 selects any one of a plurality of operation modes, and sets the selected operation mode to the mode value setting unit 104. In the present exemplary embodiment, the operation mode setting unit 103 selects any one of a plurality of operation modes according to a user operation. More specifically, according to a setting instruction from the user I/F unit 102, the operation mode setting unit 103 selects and sets the operation mode selected by the user. Furthermore, the method for setting an operation mode is not specifically limited. For example, the operation mode can be automatically set according to, for example, a feature of input image data, a type of input image data, or a usage environment of the display apparatus 101.

The mode value setting unit 104 outputs instructions for using information corresponding to the currently-set operation mode to the backlight unit 3, the drive time determination unit 11, the time correction value determination unit 13, the second correction value determination unit 17, and the first correction value storage unit 18.

For example, the mode value setting unit 104 outputs an instruction for using a current value corresponding to the currently-set operation mode to the backlight unit 3. With this, the current value corresponding to the currently-set operation mode is used at the backlight unit 3. More specifically, when the currently-set operation mode is switched from the low brightness mode to the high brightness mode, the mode value setting unit 104 outputs an instruction to increase the current value to be supplied to each color light source portion to the backlight unit 3. With this, the current value to be supplied to each color light source portion is increased from a current value corresponding to the low brightness mode to a current value corresponding to the high brightness mode. As a result, in a case where the drive time of the backlight unit 3 (each color light source portion) is kept constant, the light emission brightness of the backlight unit 3 (each color light source portion) is increased, so that the display brightness is increased.

A correspondence relationship between the light emission brightness of a color light source portion and the drive time of the color light source portion depends on a current value to be supplied to the color light source portion. Therefore, the mode value setting unit 104 outputs an instruction for using a correspondence relationship corresponding to the currently-set operation mode to the drive time determination unit 11. With this, a correspondence relationship corresponding to the currently-set operation mode is used in the drive time determination unit 11. More specifically, the drive time determination unit 11 previously stores a plurality of LUTs respectively corresponding to a plurality of operation modes as an LUT indicating a correspondence relationship between the light emission brightness of a color light source portion and the drive time of the color light source portion. Then, when the currently-set operation mode is switched, the mode value setting unit 104 outputs an instruction for using an LUT corresponding to the switched operation mode to the drive time determination unit 11. With this, the LUT to be used is switched to the LUT corresponding to the switched operation mode in the drive time determination unit 11.

The mode value setting unit 104 outputs an instruction for using a threshold value corresponding to the currently-set operation mode as a threshold value to be compared with the total drive time to the time correction value determination unit 13. With this, the threshold value corresponding to the currently-set operation mode is used in the time correction value determination unit 13. More specifically, the time correction value determination unit 13 previously stores a plurality of threshold values respectively corresponding to a plurality of operation modes as a threshold value to be compared with the total drive time. Then, when the currently-set operation mode is switched, the mode value setting unit 104 outputs an instruction for using a threshold value corresponding to the switched operation mode to the time correction value determination unit 13. With this, the threshold value to be used is switched to the threshold value corresponding to the switched operation mode in the time correction value determination unit 13. It is considered that, as a current value to be supplied to each color light source portion is larger, the upper limit of the total drive time is shorter. Therefore, in the present exemplary embodiment, in a case where the high brightness mode is set, a time shorter than that in a case where the low brightness mode is set is used as a threshold value. Furthermore, a correspondence relationship between an operation mode and a threshold value is not specifically limited. For example, in a case where the high brightness mode is set, a time longer than that in a case where the low brightness mode is set can be used as a threshold value. Moreover, the method for changing a threshold value is not limited to a method of switching the threshold value between a previously-prepared plurality of threshold values. For example, a threshold value corresponding to one operation mode can be previously prepared, and the time correction value determination unit 13 can determine a threshold value corresponding to the switched operation mode by correcting, for example, the previously-prepared threshold value or a threshold value corresponding to the switched operation mode. Then, the time correction value determination unit 13 can switch the threshold value to be used to the determined threshold value.

The luminous efficiency of a color light source portion depends on a current value to be supplied to the color light source portion. Therefore, the mode value setting unit 104 outputs an instruction for using a first correction value corresponding to the currently-set operation mode to the first correction value storage unit 18. With this, the first correction value corresponding to the currently-set operation mode is transmitted from the first correction value storage unit 18 to the drive time determination unit 11, and the first correction value corresponding to the currently-set operation mode is used in the drive time determination unit 11.

The light emission brightness of a color light source portion corresponding to the luminous efficiency of the color light source portion depends on a current value to be supplied to the color light source portion. Moreover, the mode value setting unit 104 outputs an instruction for using an initial brightness corresponding to the currently-set operation mode to the second correction value determination unit 17. With this, a second correction value is determined in the second correction value determination unit 17 using the initial brightness corresponding to the currently-set operation mode.

As described above, according to the present exemplary embodiment, a threshold value to be compared with the total drive time is changed according to a change of the currently-set operation mode. With this, displaying with electric power efficiently used can be performed. Moreover, electric power for a display apparatus can be surely prevented from exceeding the upper limit. Then, according to the present exemplary embodiment, for example, a change in luminous efficiency caused by a change of the currently-set operation mode is taken into consideration. Therefore, a high-quality image can be displayed regardless of the currently-set operation mode.

Furthermore, in the present exemplary embodiment, information updating (changing of information according to a change of the currently-set operation mode) can be omitted in some of the backlight unit 3, the drive time determination unit 11, the time correction value determination unit 13, the second correction value determination unit 17, and the first correction value storage unit 18. For example, some information updating can be omitted in consideration of, for example, the storage capacity of memory, a processing load of a display apparatus, characteristics of elements, and an image quality. More specifically, a first correction value representing a plurality of operation modes can be previously prepared, and changing of the first correction value according to a change of the operation mode can be omitted. With this, although a slight decrease in image quality of a display image (an image displayed on the screen) may occur, the total data size of the previously-prepared first correction value can be reduced. As a result, for example, an inexpensive memory with a small storage capacity can be used as the first correction value storage unit 18, so that the cost of the display apparatus can be reduced.

Furthermore, the functional units of the apparatuses in the first and second exemplary embodiments can be individual hardware units or do not need to be individual hardware units. The functions of two or more functional units can be implemented by hardware in common. Each of a plurality of functions of one functional unit can be implemented by an individual hardware unit. Two or more functions of one functional unit can be implemented by hardware in common. Moreover, each functional unit can be implemented by hardware or does not need to be implemented by hardware. For example, the apparatus can include a processor and a memory storing a control program. Then, functions of at least some functional units included in the apparatus can be implemented by the processor reading out the control program from the memory and executing the control program.

Furthermore, each of the first and second exemplary embodiments is merely an example, and a configuration obtained by modifying or changing the configurations of the first and second exemplary embodiments as appropriate within the scope of the gist of the present disclosure is also included in the present disclosure. A configuration obtained by combining some or all of the configurations of the first and second exemplary embodiments as appropriate is also included in the present disclosure.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more processors, one or more memories, circuitry, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2016-165415 filed Aug. 26, 2016, which is hereby incorporated by reference herein in its entirety.

What is claimed is:

1. A display apparatus comprising:
a light-emitting unit including a plurality of light source portions;
a display unit configured to display an image by modulating light from the light-emitting unit based on image data;
a first determination unit configured to perform, on each of the plurality of light source portions, determination processing for determining a drive value, which is a value used to perform control to set a light emission brightness of each of the plurality of light source portions to a target brightness and which is a value regarding a drive time of each of the plurality of light source portions, based on the target brightness of each the plurality of light source portions; and
a correction unit configured to correct the drive value for each of the plurality of light source portions in such a manner that, in a case where a total drive time which is a sum of a plurality of drive times respectively corresponding to the plurality of light source portions is greater than a threshold value, the total drive time becomes equal to or less than the threshold value.

2. The display apparatus according to claim 1, further comprising a second determination unit configured to determine the target brightness of each the plurality of light source portions.

3. The display apparatus according to claim 1, wherein the first determination unit determines the drive value for each of the plurality of light source portions in consideration of a luminous efficiency of each of the plurality of light source portions.

4. The display apparatus according to claim 1, wherein the determination processing is processing for determining the drive value for each of the plurality of light source portions based on the target brightness of each the plurality of light source portions, a correspondence relationship between the light emission brightness of each of the plurality of light source portions and the drive value for each the plurality of light source portions in a case where a luminous efficiency of each of the plurality of light source portions is a reference luminous efficiency, and a difference between the luminous efficiency of each of the plurality of light source portions and the reference luminous efficiency.

5. The display apparatus according to claim 4, wherein the difference between the luminous efficiency of each of the plurality of light source portions and the reference luminous efficiency includes at least one of a difference occurring during manufacturing of each the plurality of light source portions, a difference caused by a temperature change of each the plurality of light source portions, and a difference caused by an aged deterioration of each the plurality of light source portions.

6. The display apparatus according to claim 1,
wherein the drive value is a value proportional to the drive time, and
wherein, in a case where the total drive time is greater than the threshold value, the correction unit corrects the drive value for each of the plurality of light source portions by multiplying the drive value for each the plurality of light source portions by a proportion of the threshold value to the total drive time.

7. The display apparatus according to claim 1,
wherein each of the plurality of light source portions includes a plurality of color light source portions having respective different light emission colors,
wherein the first determination unit performs, on each of the plurality of color light source portions, the determination processing for determining a drive value for each the plurality of color light source portions based on a target brightness of each the plurality of color light source portions, and
wherein the correction unit corrects the drive value for each of the plurality of color light source portions in such a manner that, in a case where a second total drive time which is a sum of a plurality of drive times respectively corresponding to a plurality of color light source portions having the same light emission color is greater than a second threshold value, the second total drive time becomes equal to or less than the second threshold value.

8. The display apparatus according to claim 7,
wherein the drive value is a value proportional to the drive time, and
wherein, in a case where there is a plurality of light emission colors for which the second total drive time is greater than the second threshold value, the correction unit determines a proportion of the second threshold value to the second total drive time with respect to each of the plurality of light emission colors for which the second total drive time is greater than the second threshold value, and corrects the drive value for each of the plurality of color light source portions by multiplying the drive value for each of the plurality of color light source portions by the smallest value of a plurality of the determined proportions.

9. The display apparatus according to claim 7, wherein the second threshold value to be compared with the second total drive time varies between a plurality of light emission colors different from each other.

10. The display apparatus according to claim 1,
wherein the display apparatus has a plurality of operation modes, and
wherein, in a case where an operation mode currently set in the display apparatus is changed, the correction unit changes the threshold value to be compared with the total drive time.

11. The display apparatus according to claim 10,
wherein the plurality of operation modes includes a first mode and a second mode, in which a current value to be supplied to each the plurality of light source portions is larger than in the first mode, and
wherein, in a case where the second mode is set, a time shorter than that in a case where the first mode is set is used as the threshold value to be compared with the total drive time.

12. The display apparatus according to claim 10, further comprising a setting unit configured to set one of the plurality of operation modes according to an operation performed on the display apparatus by a user.

13. The display apparatus according to claim 1, wherein the drive time is a time equivalent to a proportion of a turning-on period of each the plurality of light source portions to a period for one frame.

14. A control method for a display apparatus, which includes a light-emitting unit including a plurality of light source portions, and a display unit configured to display an image by modulating light from the light-emitting unit based on image data, the control method comprising:
performing, on each of the plurality of light source portions, determination processing for determining a drive value, which is a value used to perform control to set a light emission brightness of each of the plurality of light source portions to a target brightness and which is a value regarding a drive time of each of the plurality of light source portions, based on the target brightness of each the plurality of light source portions; and
correcting the drive value for each of the plurality of light source portions in such a manner that, in a case where a total drive time which is a sum of a plurality of drive times respectively corresponding to the plurality of light source portions is greater than a threshold value, the total drive time becomes equal to or less than the threshold value, based on the drive value for each of the plurality of light source portions.

15. A computer-readable storage medium storing computer-executable instructions that, when executed by a computer, cause the computer to perform a control method for a display apparatus, which includes a light-emitting unit including a plurality of light source portions, and a display unit configured to display an image by modulating light from the light-emitting unit based on image data, the control method comprising:
performing, on each of the plurality of light source portions, determination processing for determining a drive value, which is a value used to perform control to set a light emission brightness of each of the plurality of light source portions to a target brightness and which is a value regarding a drive time of each of the plurality of light source portions, based on the target brightness of each the plurality of light source portions; and
correcting the drive value for each of the plurality of light source portions in such a manner that, in a case where a total drive time which is a sum of a plurality of drive times respectively corresponding to the plurality of light source portions is greater than a threshold value, the total drive time becomes equal to or less than the threshold value, based on the drive value for each of the plurality of light source portions.
